(19) United States
(12) Patent Application Publication
(10) Pub. No.: US 2016/0299303 A1
(43) Pub. Date: Oct. 13, 2016

(54) NON-LINEAR GRADIENT INDEX (GRIN) OPTICAL BACKPLANE

(71) Applicant: EMPIRE TECHNOLOGY DEVELOPMENT LLC, Wilmington, DE (US)

(72) Inventor: Benjamin William Millar, Rosebery, New South Wales (AU)

(73) Assignee: EMPIRE TECHNOLOGY DEVELOPMENT LLC, Wilmington, DE (US)

(21) Appl. No.: 15/100,988

(22) PCT Filed: Feb. 25, 2014
(86) PCT No.: PCT/US14/18203

§ 371 Date: Jun. 2, 2016

(51) Int. Cl. G02B 6/42; G02B 6/293; G02B 6/122; G02B 6/12; G02B 6/43

(52) U.S. Cl. CPC G02B 6/4257; G02B 6/12004; G02B 6/43; G02B 6/1221; G02B 6/428; G02B 6/29373; G02B 6/2938; G02B 2006/12095

(57) ABSTRACT

Technologies are generally described to fabricate an optical circuit board with a non-linear gradient index (GRIN) optical backplane. An optical backplane with a non-linear GRIN may be formed as a circuit board enabling communicative coupling between at least two components on the circuit board and/or between one or more components and an optical interface via one or more optical pathways within the optical backplane. The components may be placed at a location along one or more surfaces of the non-linear GRIN optical backplane based on an approximate angle of incidence for the optical pathways between a component and other components to be coupled to the component. The components may be further placed to enable an optical communication signal projection from the optical interface to arrive at one or more of the placed components.

### BACKGROUND

Unless otherwise indicated herein, the materials described in this section are not prior art to the claims in this application and are not admitted to be prior art by inclusion in this section.

Purely electrical circuit boards provide a mechanical and electrical framework for operating and communication among various components. Electrical communication signals may present inherent limitations on communication bandwidth and quality. For example, electrical signals may be susceptible to interference such as noise from other components on the circuit board or from external sources. On the other hand, an increasingly higher number and variety of electronic components may have the capability of optical communication. Optical communication signals may be less susceptible to interference, compared to electrical communication signals, and may provide comparatively much wider bandwidths.

Current attempts to support both electrical and optical communications on circuit boards, however, could use some improvements and/or alternative or additional solutions.

### SUMMARY

The present disclosure generally describes techniques to fabricate an optical circuit board with a non-linear gradient index (GRIN) optical backplane.

According to some examples, methods to fabricate an optical circuit board with a non-linear GRIN optical backplane are provided. An example method may include fabricating the non-linear GRIN optical backplane as part of the optical circuit board, placing a plurality of components on the optical circuit board, and providing communicative coupling between at least two of the plurality of components via optical pathways within the non-linear GRIN optical backplane.

According to other examples, an apparatus may be described. An example apparatus may include a gradient index (GRIN) optical backplane of an optical circuit board and a plurality of components placed on the GRIN optical backplane based on an approximate angle of incidence for one or more optical pathways through the non-linear GRIN optical backplane, the one or more optical pathways located between a component and other components to be in optical communication with the component via the one or more optical pathways. The example apparatus may further include an optical interface, coupled to an edge of the GRIN optical backplane, the optical interface configured to receive a first optical communication signal and provide the first optical communication signal to at least one of the components through at least one of the optical pathways in the non-linear GRIN optical backplane.

According to further examples, systems to fabricate an optical circuit board with a non-linear GRIN optical backplane are described. An example system may include a fabrication module configured to fabricate the non-linear GRIN optical backplane as the optical circuit board, where the non-linear GRIN optical backplane may comprise two or more parallel layers of distinct refractive indices in a uniform progression. The example system may also include an assembly module configured to place a plurality of components on the optical circuit board, where communicative coupling may be provided between at least two of the plurality of components via optical pathways within the non-linear GRIN optical backplane. The example system may further include a controller coupled to the fabrication module and to the assembly module, and configured to coordinate operations of the fabrication module and the assembly module, where the controller may be configured to receive instructions from a remote controller through at least one network.

According to some examples, optical backplanes are described. An example optical backplane may include a gradient index (GRIN) material formed as at least one sheet, where the sheet may include x, y, and z axes and the GRIN material may have at least one refractive index that non-linearly varies along at least one of the x, y, and z axes of the sheet. The example optical backplane may also include at least one optical pathway in the GRIN material and configured with a direction based on the non-linear variation of the at least one refractive index.

According to some examples, methods to operate optical backplanes are described. An example method may include outputting an optical communication signal from a first component located on at least one surface of a gradient index (GRIN) material formed as at least one sheet, where the sheet may include x, y, and z axes and the GRIN material may have at least one refractive index that non-linearly varies along at least one of the x, y, and z axes of the sheet. The method may further include projecting the optical communication signal from the first component to a second component, located on the at least one surface of the GRIN material, via at least one optical pathway in the GRIN material, where the optical communication signal may travel in the optical pathway along a direction based on the non-linear variation of the at least one refractive index.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

The foregoing and other features of this disclosure will become more fully apparent from the following description and appended claims, taken in conjunction with the accompanying drawings. Understanding that these drawings depict only several embodiments in accordance with the disclosure and are, therefore, not to be considered limiting of its scope, the disclosure will be described with additional specificity and detail through use of the accompanying drawings, in which:

FIG. 1A illustrates a two dimensional cross section of an example optical circuit board, where optical communication signals may be projected from one or more components to one or more other components and/or an optical interface;

FIG. 1B illustrates a two dimensional cross section of an example optical circuit board, where optical communication signals may be projected from one or more components and received by one or more other components at a particular angle of incidence;

FIG. 2A illustrates a three dimensional view of an example optical circuit board, where optical communication signals may be projected from one or more components to an optical interface coupled to an edge of a non-linear gradient index (GRIN) optical backplane;

FIG. 2B illustrates a three dimensional view of an example optical circuit board, where optical communication signals may be projected from one or more components to one or more other components on two opposite surfaces of a GRIN optical backplane;

FIG. 3 illustrates an example of optical communication signal projection within a non-linear GRIN optical backplane;

FIG. 4 illustrates one or more example pathways in which an optical communication signal may project into a non-linear GRIN optical backplane;

FIG. 5 illustrates an example system to fabricate an optical circuit board with a GRIN optical backplane;

FIG. 6 illustrates a general purpose computing device, which may be used in connection with fabrication of an optical circuit board with a GRIN optical backplane;

FIG. 7 is a flow diagram illustrating an example method to fabricate an optical circuit board with a GRIN optical backplane that may be performed or otherwise controlled by a computing device such as the computing device in FIG. 6; and

FIG. 8 illustrates a block diagram of an example computer program product, all arranged in accordance with at least some embodiments described herein.

### DETAILED DESCRIPTION

In the following detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be utilized, and other changes may be made, without departing from the spirit or scope of the subject matter presented herein. The aspects of the present disclosure, as generally described herein, and illustrated in the Figures, can be arranged, substituted, combined, separated, and designed in a wide variety of different configurations, all of which are explicitly contemplated herein.

This disclosure is generally drawn, inter alia, to methods, apparatus, systems, devices, and/or computer program products related to non-linear gradient index (GRIN) optical backplanes and optical circuit boards with non-linear GRIN optical backplanes, including fabrication thereof.

Briefly stated, technologies pertaining to an optical circuit board with a non-linear GRIN optical backplane, including fabrication thereof, are generally described. An optical backplane with a non-linear GRIN may be formed as a circuit board enabling communicative coupling between at least two components on the circuit board and/or between one or more components and an optical interface via one or more optical pathways within the optical backplane. The components may be placed at a location along one or more surfaces of the non-linear GRIN optical backplane based on an approximate angle of incidence for the optical pathways between a component and other components to be coupled to the component. The components may be further placed to enable an optical communication signal projection from the optical interface to arrive at one or more of the placed components.

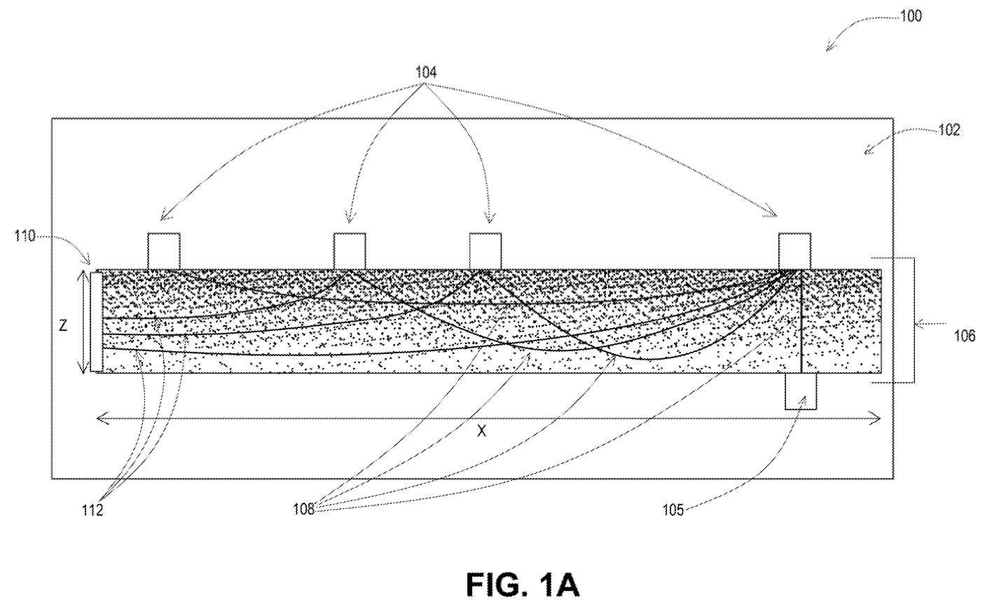

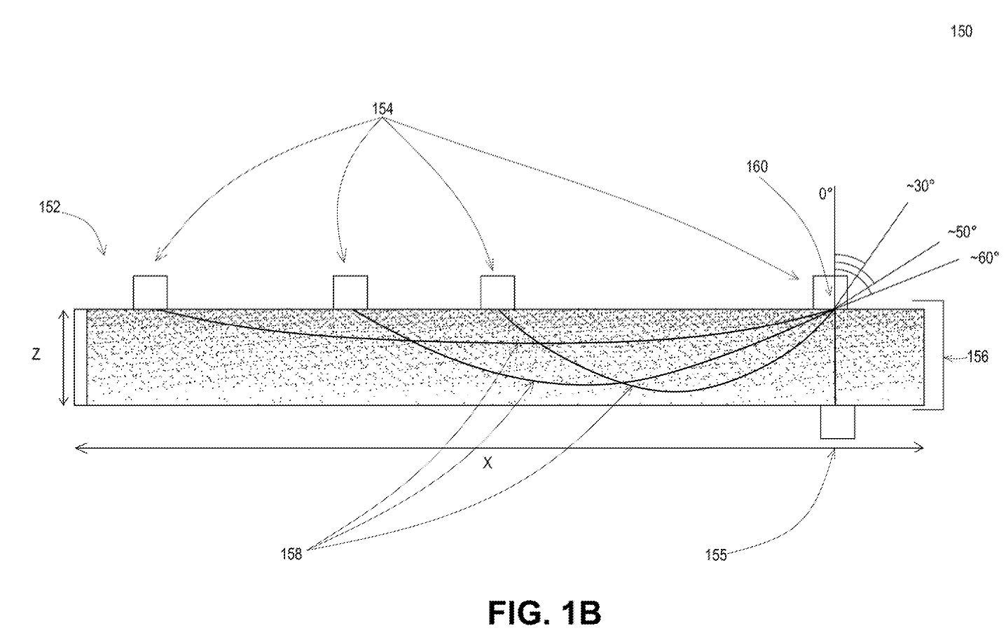

FIG. 1A illustrates a two dimensional cross section of an example optical circuit board, where optical communication signals may be projected from one or more components to one or more other components and/or an optical interface, arranged in accordance with at least some embodiments described herein.

As shown in a diagram 100, an optical circuit board 102 may include one or more components (e.g., 104 and 105), a non-linear GRIN optical backplane 106, and an optical interface 110 coupled to an edge of the non-linear GRIN optical backplane 106. Optical communication signals 108 and 112 may be projected and received by the components 104 and 105 and/or by the optical interface 110.

In an example embodiment, the components 104 and 105 may be placed along one or more surfaces of the non-linear GRIN optical backplane 106 (for example, on two opposite faces of GRIN optical backplane 106). The components 104 and 105 may be placed at locations along the one or more surfaces of the non-linear GRIN optical backplane 106 based on an approximate angle of incidence for one or more optical pathways between a component and other components to be communicatively coupled to the component. The components 104 and 105 may be enabled to project and/or receive optical communication signals 108 via the optical pathways within the non-linear GRIN optical backplane 106. Examples of the components 104 and 105 may include, but not limited to, optical receivers, optical transmitters, optical sensors, and/or others.

Components, such as component 104, may further be placed at locations along the one or more surfaces of the non-linear GRIN optical backplane 106 to enable optical communication signals 112 to be projected from the optical interface 110 and to arrive at the components. In an example embodiment, a first optical communication signal may be received by the optical interface 110. The first optical communication signal may then be provided to one or more of the components through one or more of the optical pathways in the non-linear GRIN optical backplane 106.

In an alternate or additional embodiment, a second optical communication signal may be received by the optical interface 110 from one of the components 104 and forwarded through the optical interface 110 to an external destination, for example, a fiber optic cable coupled to the optical interface 110.

Optical communication signals may include a laser beam, an infrared beam, a visible light beam, or other optical communication signals. The optical communication signals may not be internally reflected multiple times as they are rerouted. Instead, the optical communication signals may travel directly along the same path in both directions of optical communication signal transmission. The optical communication signals may turn into materials of higher refractive index and may turn away from those with lower refractive index due to phase velocity effects. As a result of the composition of the non-linear GRIN optical backplane 106, the optical communication signals projected close to the top surface (higher refractive index) may be rapidly bent. The optical communication signals projected further away closer to the bottom surface (lower refractive index) may be bent slowly to be carried to the optical interface 110.

The non-linear GRIN optical backplane 106 may be formed as a sheet, where the sheet has x, y, and z axes. Using one sheet of GRIN material comprised of a single GRIN material, two or more parallel layers of distinct refractive indices in a uniform high to low progression may form the non-linear GRIN optical backplane 106, where the gradient variance may be according to a geometric, an exponential, a non-linear, or an arbitrary formula. The parallel layers may be in a parallel orientation with reference to each other. The parallel layers may further be formed in a horizontal orientation or in a diagonal orientation. The GRIN material may be composed of poly(methyl methacrylate), perfluorinated polymers, cyclo-olefin polymers, polysulfones, sulfonated polystyrene, silica glass with gradient varying additions such as boron, or fluoride glasses, each in a mostly amorphous state, or may use other materials for the GRIN material. The non-linear GRIN optical backplane 106 may be formed by layering the GRIN material of incrementally reduced refractive index over high refractive index material, heat diffusion of multiple layers, diffusion controlled chemical reaction, chemical vapor deposition (CVD), cross-linking, partial polymerization, ion exchange, ion stuffing directional solidification, and/or other techniques.

Within the non-linear GRIN optical backplane 106, there may be at least one refractive index that non-linearly varies along the x, y, and/or z axes of the sheet and one or more optical pathways in the GRIN material may be configured with a direction based on the non-linear variation of the refractive index. For example, when the optical communication signals may be projected from one or more components to one or more other components and from the one or more components to an optical interface, the refractive index that non-linearly varies may be present along the z axis, and a substantially constant refractive index may be present along the x and y axes. Consequently, the direction of the optical pathway may be based on the gradient in the z axis. The thickness of the z axis may range from microns to several millimeters and the range of refractive gradient index from high to low may be from about 0.02 to about 0.4, for example.

In another embodiment, the optical circuit board 102 may include a linear GRIN optical backplane, where the gradient variance of the GRIN optical backplane may be according to a linear formula. The linear GRIN optical backplane may be formed as a sheet, where the sheet has x, y, and z axes and at least one refractive index that linearly varies along at least one of the x, y, and z axes of the sheet. The linear GRIN optical backplane may be composed of similar materials and formed in a similar manner to the non-linear GRIN optical backplane described above.

Forming the non-linear and/or linear refractive index gradient across a backplane may enable reception and intrinsic rerouting of optical communication signals dependent on the optical communication signals' location of incidence. The shape of the gradient index variation may be used to determine the reception and intrinsic rerouting functions. Furthermore, using the one sheet of GRIN material comprised of a single GRIN material to form the non-linear and/or linear GRIN optical backplane 106 may eliminate the need for specular reflection and greatly simplify infrastructure of an optical circuit board. The uniformity of the non-linear and/or linear GRIN optical backplane 106 may also enable backplanes to be produced on large or continuous scale and cut to size for a specific application.

FIG. 1B illustrates a two dimensional cross section of an example optical circuit board, where optical communication signals may be projected from one or more components and received by one or more other components at a particular angle of incidence, arranged in accordance with at least some embodiments described herein.

As shown in a diagram 150, an optical circuit board 152 may include one or more components 154 and 155 and a non-linear GRIN optical backplane 156. Optical communication signals 158 may be projected via one or more optical pathways within the non-linear GRIN optical backplane 156 at a particular angle of incidence 160.

The components 154 and 155 may be placed along a surface of the non-linear GRIN optical backplane 156. Optical communication signals 158 may be projected via optical pathways within the non-linear GRIN optical backplane 156 by one or more of the components and received by one or more other components to establish communicative coupling. The components may be placed on the non-linear GRIN optical backplane 156 during fabrication based on an approximate angle of incidence for the one or more optical pathways between a component and other components to be coupled to the component, ensuring communicative coupling. In other embodiments, the placement of the components may be performed in a post-fabrication stage, such as in a modular manner when a user (or other entity) may wish to swap different components onto and off of the surfaces of the non-linear GRIN optical backplane 156 so as to select/customize the components for a specific application, to upgrade or replace or add components, etc.

In one embodiment, the components 154 and 155 may project and receive optical communication signals directly from the surface of the non-linear GRIN optical backplane 156. The entry and exit angle of incidence on the edge (y-z axis) of the backplane to which the optical interface (e.g., the optical interface 110 of FIG. 1A) is coupled may be 0″, perpendicular to the surface. While, the entry and exit angle of incidence on the top (x-y axis) surface where the components are located may be close, but not equal, to 0″ so a small angle may be maintained to permit light transmission in reverse.

Optical communication signals may be projected among the components 154 and 155 on the surface(s) of the non-linear GRIN optical backplane 156, as well as between the components 154 and 155 and the optical interface coupled to the edge of the non-linear GRIN optical backplane 156. Communication among multiple components 154 and 155 may be achieved by components' emitters and/or detectors, where the emitter and/or the detector are configured to facilitate projection and/or reception of the optical communication signals among components. One or more component's emitter detector pair may form a connection via the projected optical communication signal. The non-linear GRIN optical backplane 156 may enable as many of these connections as can be placed and powered. The non-linear refractive indices of non-linear GRIN optical backplane 156 may further enable optical communication signals directed to different components 154 and 155 to cross each other without interference.

An optical communication signal may be directed to multiple destinations by multiplexing frequencies. Due to the non-linear refractive indices of the non-linear GRIN optical backplane 156, the multiplex of frequencies of the optical communication signals may project the optical communication signals to one or more components. Optical dispersion may cause optical communication signals of different wavelength to be refracted to different degrees. An optical communication signal at a fixed angle of incidence may be able to reach multiple destinations (e.g., one or more components) by projecting different wavelengths. Sufficiently dissimilar wavelengths may travel different paths, returning to the surface of the non-linear GRIN optical backplane 156 at predictable locations.

Optical docking connectors may not need to turn optical communication signals at 90′, thereby allowing simplification. Surface-to-surface optical contact as the optical communication signal is turned perpendicular by the non-linear GRIN optical backplane and refractive index matching between emitters and the non-linear GRIN optical backplane surface may also occur.

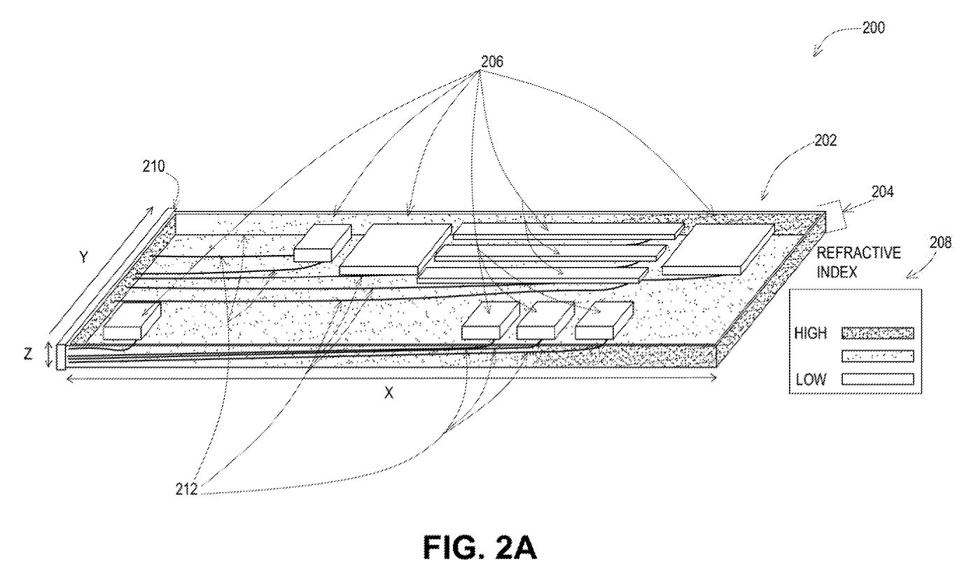

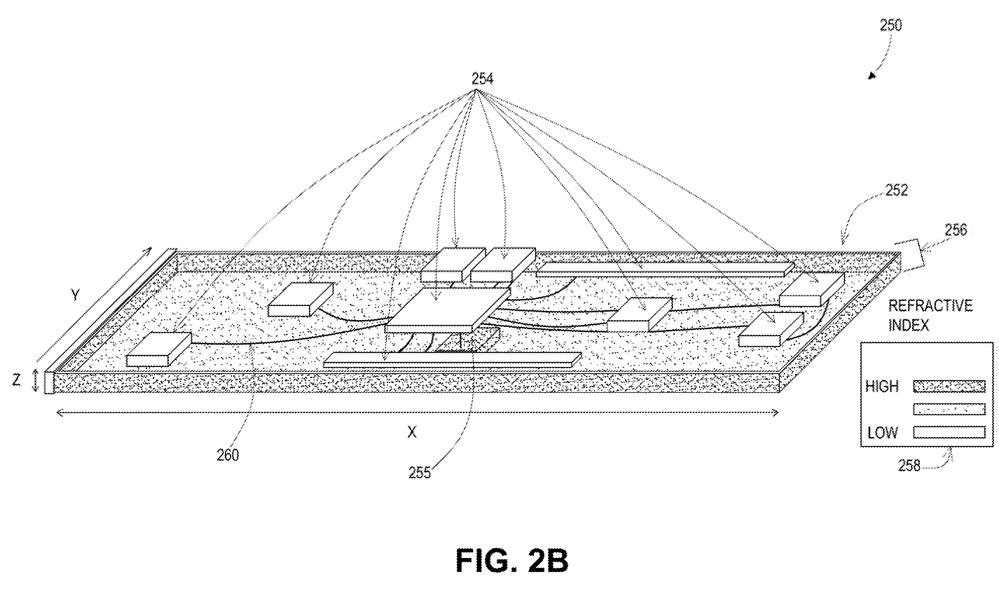

FIG. 2A illustrates a three dimensional view of an example optical circuit board, where optical communication signals may be projected from one or more components to an optical interface coupled to an edge of a non-linear GRIN optical backplane, arranged in accordance with at least some embodiments described herein.

As shown in a diagram 200, an optical circuit board 202 may include a non-linear GRIN optical backplane 204, one or more components 206, and an optical interface 210 coupled to the edge of the non-linear GRIN optical backplane 204.

Within the non-linear GRIN optical backplane 204, there may be at least one refractive index that non-linearly varies along the x, y, and/or z axes of the sheet and one or more optical pathways in the GRIN material may be configured with a direction based on the non-linear variation of the refractive index. For example, when optical communication signals are projected from the components 206 to the 210 optical interface coupled to the edge of the non-linear GRIN optical backplane 204, the refractive index that non-linearly varies may be present along the x, y, and, z axes. Consequently, the direction of the optical pathway may be based on the gradient in the x, y, and z axes.

The components 206 may be placed along a surface of the non-linear GRIN optical backplane 204. The non-linear GRIN optical backplane 204 may have a uniform progression of refractive indices 208 from a relatively higher refractive index to a relatively lower refractive index, from a top surface of the GRIN optical backplane 204 to a bottom surface of the GRIN optical backplane 204. Optical communication signals 212 may be projected from the optical interface 210 via one or more pathways within the non-linear GRIN optical backplane 204 to the components 206 (or vice versa). The non-linear refractive indices 208 of the non-linear GRIN optical backplane 204 may enable two or more optical communication signals to be directed to different components from a single emanation point at the optical interface 210.

As communicative coupling between at least two of the components 206 and/or between the components 206 and the optical interface 210 coupled to the edge of the non-linear GRIN optical backplane 204 is accomplished, the optical circuit board 202 may operate as a centralized network. The alignments and connections may be focused on the surface emitters and detectors, and large tolerances for optical alignment may be allowed, as there may be little divergence of the optical communication signal due to the direct nature of optical communication signal transmission.

Non-linear GRIN optical backplanes may be applied to any optoelectronic computing system in which high-speed data transfer may be useful. The non-linear GRIN optical backplanes may also be incorporated into optoelectronic systems. The non-linear GRIN optical backplanes may enable more pure optical computing processes beyond hybrid systems and expand systems to provide component and layout flexibility while also being highly scalable in production and operation.

FIG. 2B illustrates a three dimensional view of an example optical circuit board, where optical communication signals may be projected from one or more components to one or more other components on two opposite surfaces of a non-linear GRIN optical backplane, arranged in accordance with at least some embodiments described herein.

As shown in a diagram 250, an optical circuit board 252 may include one or more components 254 and 255 that are configured to communicate with optical communication signals 260 via one or more optical pathways within a non-linear GRIN optical backplane 256.

The components 254 and 255 may be placed along the non-linear GRIN optical backplane 256 on one or more of the surfaces of the optical circuit board 252. The non-linear GRIN optical backplane 256 may have a uniform progression of refractive indices 258 from a relatively higher refractive index to a relatively lower refractive index, from a top surface of the GRIN optical backplane 256 to a bottom surface of the GRIN optical backplane 256. Optical communication signals 260 may be projected by the one or more components 254 and 255 via one or more optical pathways within the non-linear GRIN optical backplane 256 and received by one or more other components 254 and 255 on the same and/or opposite face of the optical circuit board 252.

The projected optical communication signals may include laser beams, infrared beams, visible light beams, or other optical communication signals. The optical communication signals 260 may travel directly along the same path in both directions of optical communication signal transmission when projected among components 254 and 255. The optical communication signals 260 when projected via one or more optical pathways may turn into materials of higher refractive index and away from those with lower refractive index. As a result, the optical communication signals 260 projected close to the top surface of the non-linear GRIN optical backplane 256 may be rapidly bent and the optical communication signals 260 projected further away may be bent slowly to be carried to components 254 and 255 located further away.

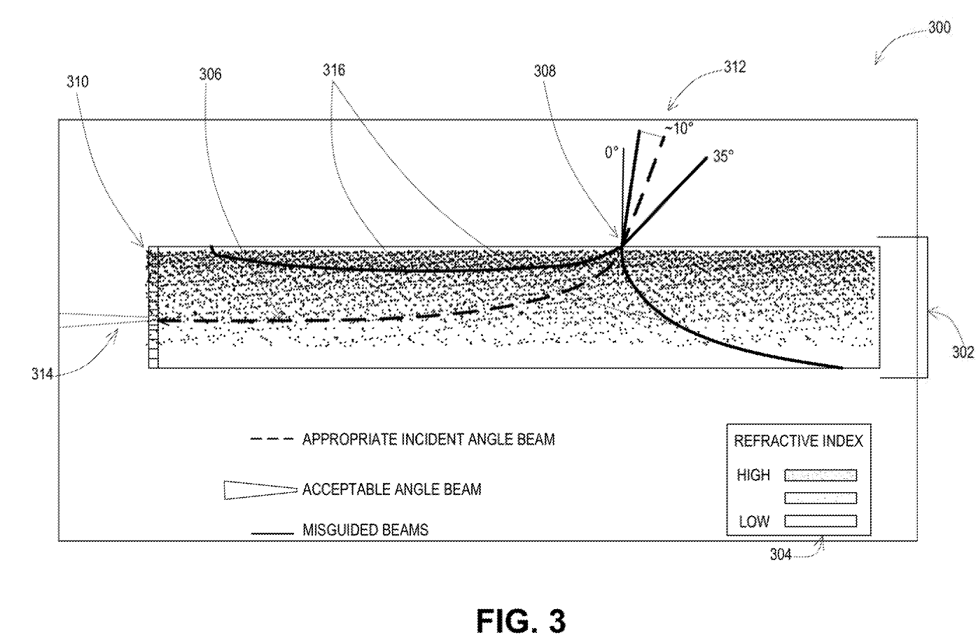

FIG. 3 illustrates an example of optical communication signal projection within a non-linear GRIN optical backplane, arranged in accordance with at least some embodiments described herein.

As shown in a diagram 300, a non-linear GRIN optical backplane 302 may have a uniform progression of refractive indices 304 from a relatively higher refractive index to a relatively lower refractive index, from a top surface of the GRIN optical backplane 302 to a bottom surface of the GRIN optical backplane 302. A component may be placed along the non-linear GRIN optical backplane 302 such that an optical communication signal 306 may be projected via one or more pathways at a particular incident angle 308. In the diagram 300, the optical communication signal 306 may be projected from a component on a surface of the non-linear GRIN optical backplane 302 at the particular incident angle 308 to an optical interface 310 coupled to an edge of the non-linear GRIN optical backplane 302 via the optical pathways. Furthermore, the optical communication signal 306 may be projected from the surface of the non-linear GRIN optical backplane 302 at an incident angle within an acceptable angle range 312 to ensure reception of the optical communication signal at an acceptable angle range 314 at the optical interface 310. Misguided beams 316 that may be projected from the surface of the non-linear GRIN optical backplane 302 outside of the acceptable angle range may not be received by the optical interface 310.

The distance traveled by an optical communication signal 306 projected from a component may be determined by the signal's particular incident angle 308 into the surface of the non-linear GRIN optical backplane 302. Small incident angles may cause the optical communication signal 306 to encounter refractive index changes more rapidly, returning the optical communication signal 306 to the surface after a short horizontal distance through the non-linear GRIN optical backplane 302. Large incident angles may provide a more gradual refractive index encounter and permit further horizontal travel through the non-linear GRIN optical backplane 302. Subsequently, optical communication signal destination may be determined by its incident angle. The optical communication signal 306 may be projected at any angle rotated around the z axis of the non-linear GRIN optical backplane 302, the axis in which the refractive index gradient exists, to reach any destination on the circuit board in the uniform x-y plane.

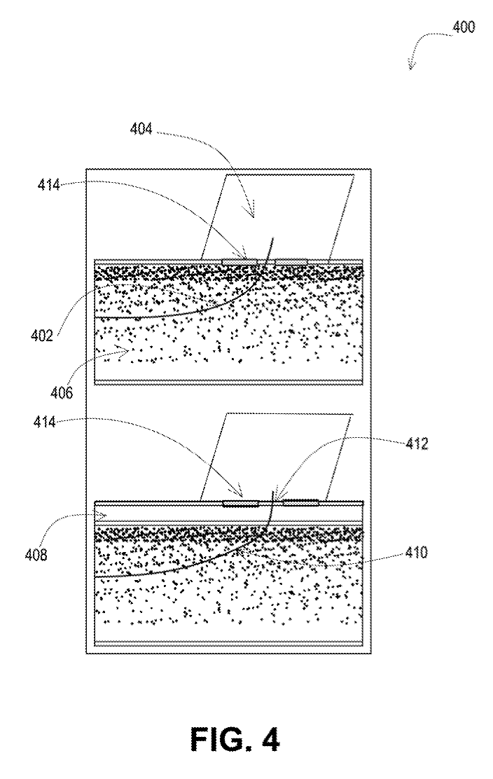

FIG. 4 illustrates one or more example pathways in which an optical communication signal may project into a non-linear GRIN optical backplane, arranged in accordance with at least some embodiments described herein.

As shown in a diagram 400, in one embodiment, an optical communication signal 402 may be projected from a component 404 directly into a surface of a non-linear GRIN optical backplane 406 at a particular incident angle, with the optical communication signal source contacting the backplane surface. In another embodiment, a layer of rigid protective material 408, such as epoxy resin, may be fabricated onto a circuit board and an optical communication signal 410 may be projected into the backplane surface through a polymer tip 412 that has a refractive index matched to that of the backplane surface at the particular incident angle.

In each embodiment, a conductive layer 414 may also be deposited to the surface of the non-linear GRIN optical backplane 406 to provide conductive traces for electrical communications (and/or power supply to one or more components). The conductive layer 414 may also operate as a heat pipe and sink for various components.

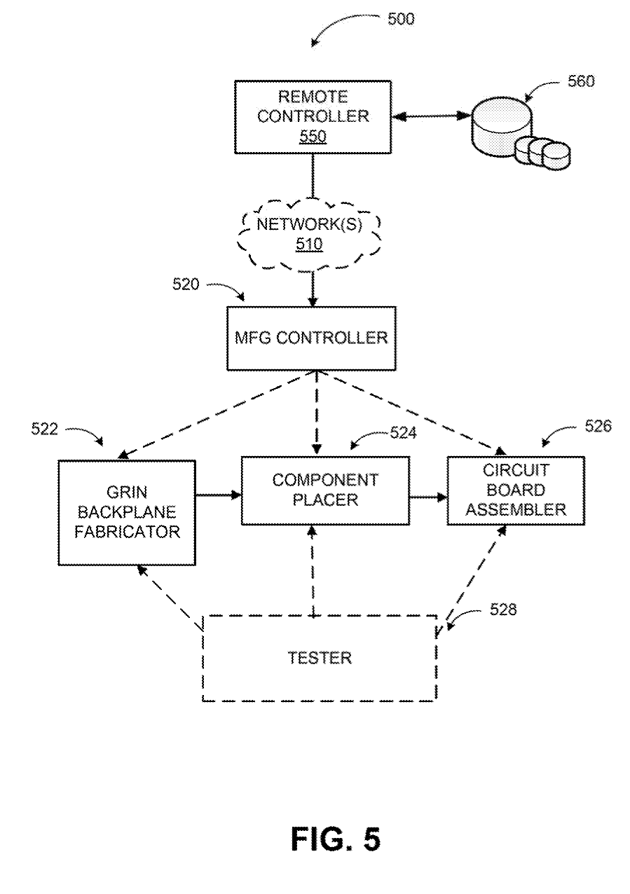

FIG. 5 illustrates an example system to fabricate a circuit board with a GRIN optical backplane, arranged in accordance with at least some embodiments described herein.

System 500 may include a manufacturing controller 520, a GRIN backplane fabricator 522, a component placer 524, a circuit board assembler 526, and an optional tester 528. The manufacturing controller 520 may be operated by human control or may be configured for automatic operation, or may be directed by a remote controller 550 through at least one network (for example, via network 510). Data associated with controlling the different processes of circuit board fabrication may be stored at and/or received from data stores 560.

The manufacturing controller 520 may include or control a fabrication module configured to form the GRIN optical backplane, and an assembly module configured to place one or more components on an optical circuit board and assemble the optical circuit board by attaching the placed components. In one embodiment, such a fabrication module may comprise the GRIN backplane fabricator 522 and such an assembly module may comprise the component placer 524 and circuit board assembler 526 shown in FIG. 5. The GRIN backplane fabricator 522 may use two or more parallel layers of distinct refractive indices in a uniform high to low progression to form the backplane using a single piece and/or sheet of GRIN material comprising x, y, and z axes. The GRIN optical backplane may be formed by layering the GRIN material of incrementally reduced refractive index material over high (or relatively higher) refractive index material, heat diffusion of multiple layers, diffusion controlled chemical reaction, chemical vapor deposition (CVD), cross-linking, partial polymerization, ion exchange, ion stuffing, directional solidification, and/or other techniques. In one embodiment, the GRIN optical backplane may be formed to include at least one refractive index that non-linearly varies along at least one of the x, y, and z axes of the sheet. For example, a gradient variance of the GRIN optical backplane may be according to a geometric, an exponential, a non-linear, or an arbitrary formula. In another embodiment, the GRIN optical backplane may be formed to include at least one refractive index that linearly varies along at least one of the x, y, and z axes of the sheet. For example, the gradient variance of the GRIN optical backplane may be according to a linear formula.

The component placer 524 may place the components along one or more surfaces of the GRIN optical backplane (for example, on two opposite faces) of the optical circuit board. The components may be placed at a location along one or more surfaces of the GRIN backplane based on an approximate angle of incidence for the one or more optical pathways between a component and other components to be coupled to the component. The components may be further placed to enable an optical communication signal projection from an optical interface coupled to an edge of the GRIN optical backplane to arrive at one or more of the placed components. A layer of conductive traces may further be placed over the GRIN optical backplane and/or a combination layer of conductive traces and GRIN optical backplane may be formed to provide power. For example, a copper sheet may be adhered or deposited to a surface of the GRIN optical backplane to act as the layer of conductive traces.

Following placement, the circuit board assembler 526 may then attach the components to the optical circuit board by gluing, soldering, ultrasonic welding, or another attachment technique. The optional tester 528 may test the GRIN optical backplane, the components, and the optical pathways for established communicative coupling at various stages of fabrication.

The examples in FIGS. 1 through 5 have been described using specific processes and applications in which fabrication of an optical circuit board with a GRIN optical backplane may be implemented to provide communicative coupling between at least two or more components. Embodiments for fabrication a circuit board with a non-linear GRIN optical backplane are not limited to the processes and applications according to these examples.

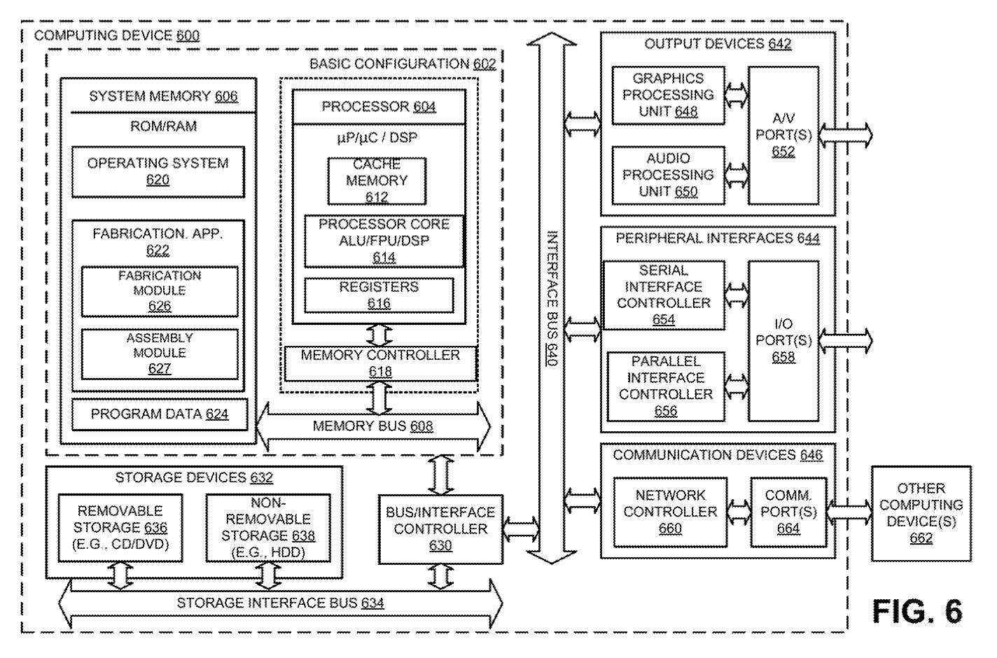

FIG. 6 illustrates a general purpose computing device, which may be used in connection with fabrication of an optical circuit board with a GRIN optical backplane, arranged in accordance with at least some embodiments described herein.

For example, the computing device 600 may be used to manage or otherwise control a fabrication process of a circuit board with a GRIN optical backplane as described herein. In an example basic configuration 602, the computing device 600 may include one or more processors 604 and a system memory 606. A memory bus 608 may be used for communicating between the processor 604 and the system memory 606. The basic configuration 602 is illustrated in FIG. 6 by those components within the inner dashed line.

Depending on the desired configuration, the processor 604 may be of any type, including but not limited to a microprocessor (μP), a microcontroller (μC), a digital signal processor (DSP), or any combination thereof. The processor 604 may include one more levels of caching, such as a level cache memory 612, a processor core 614, and registers 616. The example processor core 614 may include an arithmetic logic unit (ALU), a floating point unit (FPU), a digital signal processing core (DSP Core), or any combination thereof. An example memory controller 618 may also be used with the processor 604, or in some implementations the memory controller 618 may be an internal part of the processor 604.

Depending on the desired configuration, the system memory 606 may be of any type including but not limited to volatile memory (such as RAM), non-volatile memory (such as ROM, flash memory, etc.) or any combination thereof. The system memory 606 may include an operating system 620, a fabrication application 622, and program data 624. The fabrication application 622 may include a fabrication module 626 and an assembly module 627 to fabricate and assemble an optical circuit board with a GRIN optical backplane as described herein. In some embodiments, the GRIN backplane fabricator 522 may be used to implement the fabrication module 626, and one or more of the component placer 524 and the circuit board assembler 526 may be used to implement the assembly module 627.

The computing device 600 may have additional features or functionality, and additional interfaces to facilitate communications between the basic configuration 602 and any desired devices and interfaces. For example, a bus/interface controller 630 may be used to facilitate communications between the basic configuration 602 and one or more data storage devices 632 via a storage interface bus 634. The data storage devices 632 may be one or more removable storage devices 636, one or more non-removable storage devices 638, or a combination thereof. Examples of the removable storage and the non-removable storage devices include magnetic disk devices such as flexible disk drives and hard-disk drives (HDDs), optical disk drives such as compact disk (CD) drives or digital versatile disk (DVD) drives, solid state drives (SSDs), and tape drives to name a few. Example computer storage media may include volatile and nonvolatile, removable and non-removable media implemented in any method or technology for storage of information, such as computer readable instructions, data structures, program modules, or other data.

The system memory 606, the removable storage devices 636 and the non-removable storage devices 638 are examples of computer storage media. Computer storage media includes, but is not limited to, RAM, ROM, EEPROM, flash memory or other memory technology, CD-ROM, digital versatile disks (DVDs), solid state drives, or other optical storage, magnetic cassettes, magnetic tape, magnetic disk storage or other magnetic storage devices, or any other medium which may be used to store the desired information and which may be accessed by the computing device 600. Any such computer storage media may be part of the computing device 600.

The computing device 600 may also include an interface bus 640 for facilitating communication from various interface devices (for example, one or more output devices 642, one or more peripheral interfaces 644, and one or more communication devices 646) to the basic configuration 602 via the bus/interface controller 630. Some of the example output devices 642 include a graphics processing unit 648 and an audio processing unit 650, which may be configured to communicate to various external devices such as a display or speakers via one or more A/V ports 652. One or more example peripheral interfaces 644 may include a serial interface controller 654 or a parallel interface controller 656, which may be configured to communicate with external devices such as input devices (for example, keyboard, mouse, pen, voice input device, touch input device, etc.) or other peripheral devices (for example, printer, scanner, etc.) via one or more I/O ports 658. An example communication device 646 includes a network controller 660, which may be arranged to facilitate communications with one or more other computing devices 662 over a network communication link via one or more communication ports 664. The one or more other computing devices 662 may include servers at a datacenter, customer equipment, and comparable devices.

The network communication link may be one example of a communication media. Communication media may typically be embodied by computer readable instructions, data structures, program modules, or other data in a modulated data signal, such as a carrier wave or other transport mechanism, and may include any information delivery media. A “modulated data signal” may be a signal that has one or more of its characteristics set or changed in such a manner as to encode information in the signal. By way of example, and not limitation, communication media may include wired media such as a wired network or direct-wired connection, and wireless media such as acoustic, radio frequency (RF), microwave, infrared (IR) and other wireless media. The term computer readable media as used herein may include both storage media and communication media.

The computing device 600 may be implemented as a part of a general purpose or specialized server, mainframe, or similar computer that includes any of the above functions. The computing device 600 may also be implemented as a personal computer including both laptop computer and non-laptop computer configurations.

Example embodiments may also include methods to fabricate a circuit board with a non-linear GRIN optical backplane. These methods can be implemented in any number of ways, including the structures described herein. One such way may be by machine operations, of devices of the type described in the present disclosure. Another optional way may be for one or more of the individual operations of the methods to be performed in conjunction with one or more human operators performing some of the operations while other operations may be performed by machines. These human operators need not be collocated with each other, but each can be with a machine that performs a portion of the program. In other examples, the human interaction can be automated such as by pre-selected criteria that may be machine automated.

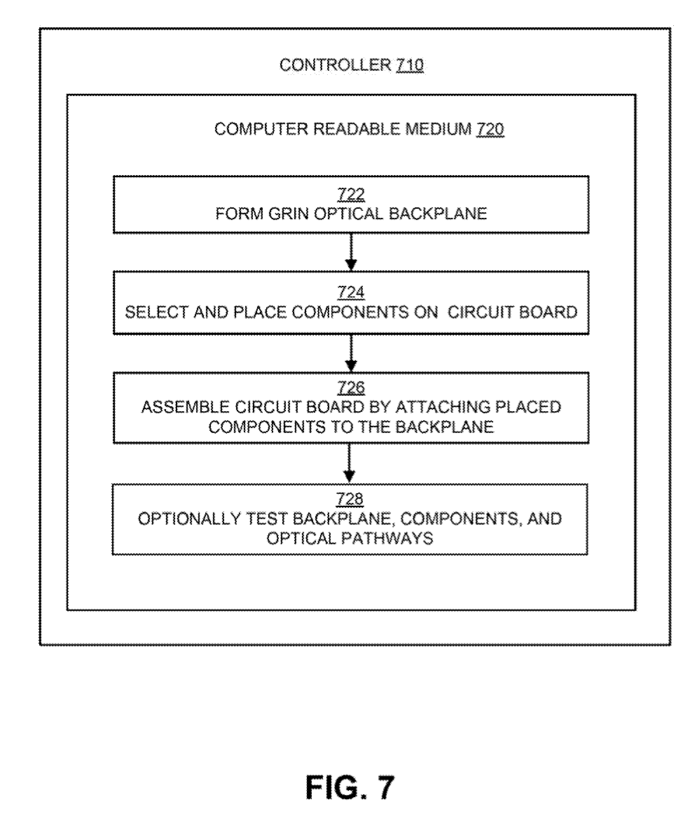

FIG. 7 is a flow diagram illustrating an example method to fabricate an optical circuit board with a GRIN optical backplane that may be performed or otherwise controlled by a computing device such as the computing device in FIG. 6, arranged in accordance with at least some embodiments described herein.

Example methods may include one or more operations, functions or actions as illustrated by one or more of blocks 722, 724, 726 and/or 728, and may in some embodiments be performed by a computing device such as the computing device 600 in FIG. 6. The operations described in the blocks 722-728 may also be stored as computer-executable instructions in a computer-readable medium such as a computer-readable medium 720 of a computing device 710.

An example process to fabricate an optical circuit board with a GRIN optical backplane and one or more components may begin with block 722, “FORM GRIN OPTICAL BACKPLANE”, where a GRIN backplane fabricator (e.g., the GRIN backplane fabricator 522) may form a GRIN optical backplane (e.g., the GRIN optical backplane 106) as a sheet, and fabricate the GRIN optical backplane as a part of an optical circuit board. The GRIN optical backplane may comprise at least one sheet of the GRIN material comprised of a single GRIN material, where the sheet has x, y, and z axes. The sheet may be formed from two or more parallel layers of distinct refractive indices in a uniform high to low progression. The GRIN material may have at least one refractive index that non-linearly varies along at least one of the x, y, and/or z axes of the sheet, and at least one optical pathway in the GRIN material may be configured with a direction based on the non-linear variation of the at least one refractive index. In another embodiment, the GRIN material may have at least one refractive index that linearly varies along at least one of the x, y, and/or z axes of the sheet, and at least one optical pathway in the GRIN material may be configured with a direction based on the linear variation of the at least one refractive index.

Block 722 may be followed by block 724, “SELECT AND PLACE COMPONENTS ON CIRCUIT BOARD”, where a component placer 524 may place one or more components (e.g., the components 104 and 105) along one or more surfaces of the GRIN optical backplane fabricated as part of the optical circuit board. The components may be placed at a location along one or more surfaces of the GRIN backplane based on an approximate angle of incidence (e.g., the angle of incidence 160) for the one or more optical pathways between a component and other components to be coupled to the component. The components may be further placed to enable an optical communication signal projection from an optical interface coupled to an edge of the GRIN optical backplane to arrive at one or more of the placed components.

Block 724 may be followed by block 726, “ASSEMBLE CIRCUIT BOARD BY ATTACHING PLACED COMPONENTS TO THE BACKPLANE”, where a circuit board assembler (e.g., the circuit board assembler 526) may attach the one or more placed components to one or more surfaces of the optical circuit board by gluing, soldering, ultrasonic welding, or attachment technique.

Block 726 may be followed by block 728, “OPTIONALLY TEST BACKPLANE, COMPONENTS, AND OPTICAL PATHWAYS”, where an optional tester (e.g., the optional tester 528) may test the GRIN optical backplane, the one or more components, and the one or more optical pathways for established communicative coupling at various stages of fabrication.

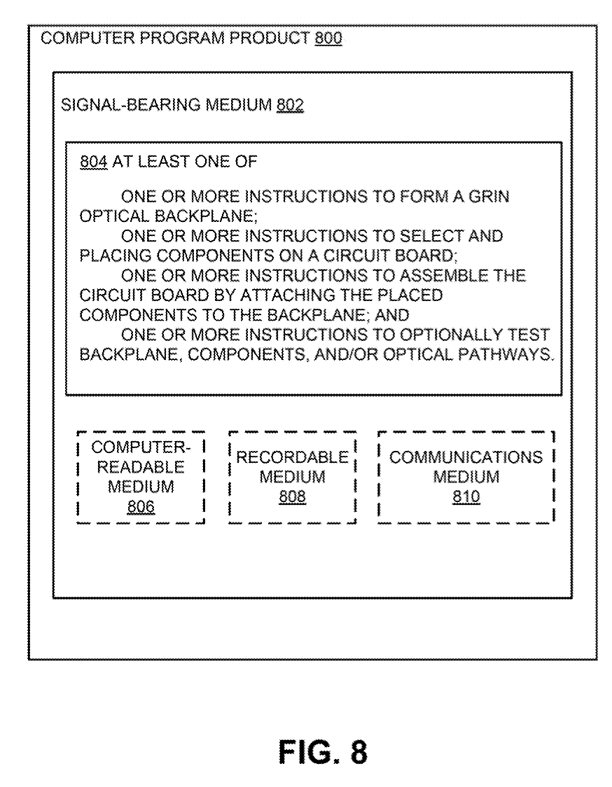

FIG. 8 illustrates a block diagram of an example computer program product, arranged in accordance with at least some embodiments described herein.

In some examples, as shown in FIG. 8, the computer program product 800 may include a signal bearing medium 802 that may also include one or more machine readable instructions 804 that, in response to execution by, for example, a processor may provide the features and operations described herein. Thus, for example, referring to the processor 604 in FIG. 6, the fabrication application 622, the fabrication module 626, or the assembly module 627 may undertake one or more of the tasks shown in FIG. 8 in response to the instructions 804 conveyed to the processor 604 by the medium 802 to perform actions associated with fabrication of an optical circuit board with a non-linear GRIN optical backplane as described herein. Some of those instructions may be, for example, to form a GRIN optical backplane, to select and place components on a circuit board, to assemble the circuit board by attaching the placed components to the backplane, and to optionally test backplane, components, and optical pathways, according to some embodiments described herein.

In some implementations, the signal bearing medium 802 depicted in FIG. 8 may encompass a computer-readable medium 806, such as, but not limited to, a hard disk drive, a solid state drive, a Compact Disc (CD), a Digital Versatile Disk (DVD), a digital tape, memory, etc. In some implementations, the signal bearing medium 802 may encompass a recordable medium 808, such as, but not limited to, memory, read/write (RIW) CDs, R/W DVDs, etc. In some implementations, the signal bearing medium 802 may encompass a communications medium 810, such as, but not limited to, a digital and/or an analog communication medium (for example, a fiber optic cable, a waveguide, a wired communications link, a wireless communication link, etc.). Thus, for example, the program product 800 may be conveyed to one or more modules of the processor 604 by an RF signal bearing medium, where the signal bearing medium 802 is conveyed by the wireless communications medium 810 (for example, a wireless communications medium conforming with the IEEE 802.11 standard).

According to some examples, methods are provided to fabricate an optical circuit board with a non-linear gradient index (GRIN) optical backplane. An example method may include fabricating the non-linear GRIN optical backplane as part of the optical circuit board, placing a plurality of components on the optical circuit board, and providing communicative coupling between at least two of the plurality of components via optical pathways within the non-linear GRIN optical backplane.

In other examples, the non-linear GRIN optical backplane, the plurality of components, and optical pathways may be tested for established communicative coupling. The two or more parallel layers of distinct refractive indices may be formed in a uniform progression to fabricate the non-linear GRIN optical backplane, where the parallel layers may be formed a horizontal orientation or a diagonal orientation and the uniform progression of the refractive indices may be from a relatively higher refractive index to a relatively lower refractive index, from a top surface of the GRIN optical backplane to a bottom surface of the GRIN optical backplane. The non-linear GRIN optical backplane may be fabricated by layering GRIN material through layering incrementally reduced refractive index material over relatively higher refractive index material, heat diffusion of multiple layers, diffusion controlled chemical reaction, chemical vapor deposition (CVD), cross-linking, partial polymerization, ion exchange, ion stuffing, and/or directional solidification.

In further examples, each component may be placed at a location on the optical circuit board based on an approximate angle of incidence for one or more optical pathways between a component and other components to be coupled to the component and a portion of the components may be placed on two opposite surfaces of the optical circuit board. The plurality of components may be further placed on the optical circuit board to enable an optical communication signal projection from an optical interface coupled to an edge of the non-linear GRIN optical backplane to arrive at one or more of the placed plurality components. A layer of conductive traces may be formed over at least one surface of the non-linear GRIN optical backplane. The plurality of components may be attached to the optical circuit board by gluing, soldering, and/or ultrasonic welding.

According to some embodiments, an apparatus is described. An example of the apparatus may include a gradient index (GRIN) optical backplane of an optical circuit board and a plurality of components placed on the GRIN optical backplane based on an approximate angle of incidence for one or more optical pathways through the non-linear GRIN optical backplane, the one or more optical pathways located between a component and other components to be in optical communication with the component via the one or more optical pathways. The example apparatus may further include an optical interface, coupled to an edge of the GRIN optical backplane, the optical interface configured to receive a first optical communication signal and provide the first optical communication signal to at least one of the components through at least one of the optical pathways in the non-linear GRIN optical backplane.

In other embodiments, the optical interface may be further configured to receive a second optical communication signal from at least one of the components through an optical pathway in the GRIN optical backplane and to provide the second optical communication signal to an external destination. The GRIN optical backplane may be formed from a single GRIN material, where the GRIN material may include poly(methyl methacrylate), perfluorinated polymers, cyclo-olefin polymers, polysulfones, sulfonated polystyrene, silica glass with gradient varying additions, or fluoride glass. The GRIN optical backplane may comprise a sheet that includes x, y, and z axes and includes at least one refractive index that non-linearly varies along at least one of the x, y, and z axes of the sheet. The GRIN optical backplane may comprise a sheet that includes x, y, and z axes and includes at least one refractive index that linearly varies along at least one of the x, y, and z axes of the sheet. A layer of conductive traces may be formed on at least a surface of the non-linear GRIN optical backplane.

In further embodiments, the first optical communication signal may be a laser beam, an infrared beam, and/or a visible light beam. The GRIN optical backplane has non-linear refractive indices such that optical communication signals directed to different components may cross each other without interference, communication signals may be directed to different components from a single emanation point at the optical interface, and a multiplex of frequencies of the optical communication signals may project the optical communication signals to one or more components. A portion of the plurality of components may include an emitter and/or a detector, where the emitter and/or the detector may be configured to facilitate projection and/or reception of the optical communication signals.

According to some examples, systems to fabricate an optical circuit board with a non-linear gradient index (GRIN) optical backplane are described. An example system may include a fabrication module configured to fabricate the non-linear GRIN optical backplane as the optical circuit board, where the non-linear GRIN optical backplane may comprise two or more parallel layers of distinct refractive indices in a uniform progression. The example system may also include an assembly module configured to place a plurality of components on the optical circuit board, where communicative coupling may be provided between at least two of the plurality of components via optical pathways within the non-linear GRIN optical backplane. The example system may further include a controller coupled to the fabrication module and to the assembly module, and configured to coordinate operations of the fabrication module and the assembly module, where the controller may be configured to receive instructions from a remote controller through at least one network.

In other examples, the example system may further include a test module configured to test the non-linear GRIN optical backplane, the plurality of components, and optical pathways for established communicative coupling. The assembly module may be configured to select a location of each component based on an approximate angle of incidence for one or more optical pathways between a component and other components to be coupled to the component. The assembly module may be further configured to place the components on the optical circuit board to enable an optical communication signal projection from an optical interface coupled to an edge of the non-linear GRIN optical backplane to arrive at the placed components. The fabrication module may be configured to form a layer of conductive traces over at least one surface of the non-linear GRIN optical backplane.

According to some embodiments, optical backplanes are described. An example optical backplane may include a gradient index (GRIN) material formed as at least one sheet, where the sheet may include x, y, and z axes and the GRIN material may have at least one refractive index that non-linearly varies along at least one of the x, y, and z axes of the sheet. The example optical backplane may also include at least one optical pathway in the GRIN material and configured with a direction based on the non-linear variation of the at least one refractive index.

In other embodiments, the at least one sheet of the GRIN material may comprise a single GRIN material sheet and may be poly(methyl methacrylate), perfluorinated polymers, cyclo-olefin polymers, polysulfones, sulfonated polystyrene, silica glass with gradient varying additions, or fluoride glass. The at least one sheet of the GRIN material may be formed from two or more parallel layers of distinct refractive indices in a uniform progression, where the two or more parallel layers may be formed in one of a horizontal orientation or a diagonal orientation and the uniform progression of the refractive indices may be from a relatively higher refractive index to a relatively lower refractive index, from a top surface of the GRIN material to a bottom surface of the GRIN material. The at least one sheet of the GRIN material may be formed from layers of the GRIN material.

In further embodiments, the at least one refractive index that non-linearly varies may be present along the z axis, and a substantially constant refractive index is present along the x and y axes. The example optical backplane may further include a layer of conductive traces on at least a surface of the GRIN material. The at least one refractive index that non-linearly varies may be arranged in the GRIN material such that optical communication signals directed to different components, located on at least one surface of the GRIN material, may cross each other without interference, two or more optical communication signals may be directed to different components, located on at least one surface of the GRIN material, from a single emanation point at an optical interface, and a multiplex of frequencies of optical communication signals may project the optical communication signals to one or more components located on a surface of the GRIN material.

According to some example, methods to operate an optical backplane are described. An example method may include outputting an optical communication signal from a first component located on at least one surface of a gradient index (GRIN) material formed as at least one sheet, where the sheet may include x, y, and z axes and the GRIN material may have at least one refractive index that non-linearly varies along at least one of the x, y, and z axes of the sheet. The method may further include projecting the optical communication signal from the first component to a second component, located on the at least one surface of the GRIN material, via at least one optical pathway in the GRIN material, where the optical communication signal may travel in the optical pathway along a direction based on the non-linear variation of the at least one refractive index.

In other examples, the optical communication signal may be projected from the first component to the second component at a particular angle of incidence. The optical communication signal may also be projected from the first component to an optical interface coupled to an edge of the non-linear GRIN optical backplane, where the optical interface may be configured to receive and provide the optical communication signal from the first component to the second component via the at least one optical pathway in the GRIN material.

Various embodiments may be implemented in hardware, software, or combination of both hardware and software (or other computer-readable instructions stored on a non-transitory computer-readable storage medium and executable by one or more processors); the use of hardware or software is generally (but not always, in that in certain contexts the choice between hardware and software may become significant) a design choice representing cost vs. efficiency tradeoffs. There are various vehicles by which processes and/or systems and/or other technologies described herein may be effected (for example, hardware, software, and/or firmware), and that the preferred vehicle will vary with the context in which the processes and/or systems and/or other technologies are deployed. For example, if an implementer determines that speed and accuracy are paramount, the implementer may opt for a mainly hardware and/or firmware vehicle; if flexibility is paramount, the implementer may opt for a mainly software implementation; or, yet again alternatively, the implementer may opt for some combination of hardware, software, and/or firmware.

The foregoing detailed description has set forth various embodiments of the devices and/or processes via the use of block diagrams, flowcharts, and/or examples. Insofar as such block diagrams, flowcharts, and/or examples contain one or more functions and/or operations, each function and/or operation within such block diagrams, flowcharts, or examples may be implemented, individually and/or collectively, by a wide range of hardware, software, firmware, or virtually any combination thereof. In one embodiment, several portions of the subject matter described herein may be implemented via Application Specific Integrated Circuits (ASICs), Field Programmable Gate Arrays (FPGAs), digital signal processors (DSPs), or other integrated formats. However, some aspects of the embodiments disclosed herein, in whole or in part, may be equivalently implemented in integrated circuits, as one or more computer programs running on one or more computers (for example, as one or more programs running on one or more computer systems), as one or more programs running on one or more processors (for example, as one or more programs running on one or more microprocessors), as firmware, or as virtually any combination thereof, and that designing the circuitry and/or writing the code for the software and or firmware are possible in light of this disclosure.

The present disclosure is not to be limited in terms of the particular embodiments described in this application, which are intended as illustrations of various aspects. Many modifications and variations can be made without departing from its spirit and scope Functionally equivalent methods and apparatuses within the scope of the disclosure, in addition to those enumerated herein, will be apparent from the foregoing descriptions. Such modifications and variations are intended to fall within the scope of the appended claims. The present disclosure is to be limited only by the terms of the appended claims, along with the full scope of equivalents to which such claims are entitled. It is also to be understood that the terminology used herein is for the purpose of describing particular embodiments only, and is not intended to be limiting.

In addition, the mechanisms of the subject matter described herein are capable of being distributed as a program product in a variety of forms, and that an illustrative embodiment of the subject matter described herein applies regardless of the particular type of signal bearing medium used to actually carry out the distribution. Examples of a signal bearing medium include, but are not limited to, the following: a recordable type medium such as a floppy disk, a hard disk drive, a Compact Disc (CD), a Digital Versatile Disk (DVD), a digital tape, a computer memory, a solid state drive, etc.; and a transmission type medium such as a digital and/or an analog communication medium (for example, a fiber optic cable, a waveguide, a wired communications link, a wireless communication link, etc.).

Those skilled in the art will recognize that it is common within the art to describe devices and/or processes in the fashion set forth herein, and thereafter use engineering practices to integrate such described devices and/or processes into data processing systems. That is, at least a portion of the devices and/or processes described herein may be integrated into a data processing system via a reasonable amount of experimentation. Those having skill in the art will recognize that a typical data processing system generally includes one or more of a system unit housing, a video display device, a memory such as volatile and non-volatile memory, processors such as microprocessors and digital signal processors, computational entities such as operating systems, drivers, graphical user interfaces, and applications programs, one or more interaction devices, such as a touch pad or screen, and/or control systems including feedback loops and control motors.

The herein described subject matter sometimes illustrates different components contained within, or connected with, different other components. It is to be understood that such depicted architectures are merely exemplary, and that in fact many other architectures may be implemented which achieve the same functionality. In a conceptual sense, any arrangement of components to achieve the same functionality is effectively “associated” such that the desired functionality is achieved. Hence, any two components herein combined to achieve a particular functionality may be seen as “associated with” each other such that the desired functionality is achieved, irrespective of architectures or intermediate components. Likewise, any two components so associated may also be viewed as being “operably connected”, or “operably coupled”, to each other to achieve the desired functionality, and any two components capable of being so associated may also be viewed as being “operably couplable”, to each other to achieve the desired functionality. Specific examples of operably couplable include but are not limited to physically connectable and/or physically interacting components and/or wirelessly interactable and/or wirelessly interacting components and/or logically interacting and/or logically interactable components.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (for example, bodies of the appended claims) are generally intended as “open” terms (for example, the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (for example, “a” and/or “an” should be interpreted to mean “at least one” or “one or more”); the same holds true for the use of definite articles used to introduce claim recitations. In addition, even if a specific number of an introduced claim recitation is explicitly recited, those skilled in the art will recognize that such recitation should be interpreted to mean at least the recited number (for example, the bare recitation of “two recitations,” without other modifiers, means at least two recitations, or two or more recitations).

Furthermore, in those instances where a convention analogous to “at least one of A, B, and C, etc.” is used, in general such a construction is intended in the sense one having skill in the art would understand the convention (for example, “a system having at least one of A, B, and C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

In addition, where features or aspects of the disclosure are described in terms of Markush groups, those skilled in the art will recognize that the disclosure is also thereby described in terms of any individual member or subgroup of members of the Markush group.

As will be understood by one skilled in the art, for any and all purposes, such as in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, etc. As a non-limiting example, each range discussed herein can be readily broken down into a lower third, middle third and upper third, etc. As will also be understood by one skilled in the art all language such as “up to,” “at least,” “greater than,” “less than,” and the like include the number recited and refer to ranges which can be subsequently broken down into subranges as discussed above. Finally, as will be understood by one skilled in the art, a range includes each individual member. Thus, for example, a group having 1-3 cells refers to groups having 1, 2, or 3 cells. Similarly, a group having 1-5 cells refers to groups having 1, 2, 3, 4, or 5 cells, and so forth.

While various aspects and embodiments have been disclosed herein, other aspects and embodiments are possible. The various aspects and embodiments disclosed herein are for purposes of illustration and are not intended to be limiting, with the true scope and spirit being indicated by the following claims.

1. A method to fabricate an optical circuit board with a non-linear gradient index (GRIN) optical backplane, the method comprising:
fabricating the non-linear GRIN optical backplane as part of the optical circuit board;
placing a plurality of components on the optical circuit board based on an approximate angle of incidence for one or more optical pathways within the non-linear GRIN optical backplane, and wherein placing the plurality of components on the optical circuit board includes placing the plurality of components on the optical circuit board to enable an optical communication signal projection from an optical interface coupled to an edge of the non-linear GRIN optical backplane to arrive at one or more of the placed plurality components; and
providing communicative coupling between at least two of the plurality of components via the one or more optical pathways within the non-linear GRIN optical backplane.

2. The method of claim 1, further comprising:
testing the non-linear GRIN optical backplane, the plurality of components, and optical pathways for established communicative coupling.

3. The method of claim 1, further comprising:
forming two or more parallel layers of distinct refractive indices in a uniform progression to fabricate the non-linear GRIN optical backplane.

4. The method of claim 3, wherein forming the two or more parallel layers includes:
forming the two or more parallel layers in one of a horizontal orientation or a diagonal orientation.

5. The method of claim 3, wherein the uniform progression of the refractive indices is from a relatively higher refractive index to a relatively lower refractive index, from a top surface of the GRIN optical backplane to a bottom surface of the GRIN optical backplane.

6. The method of claim 1, wherein fabricating the non-linear GRIN optical backplane includes:
fabricating the non-linear GRIN optical backplane by layering GRIN material through one or more of: layering incrementally reduced refractive index material over relatively higher refractive index material, heat diffusion of multiple layers, diffusion controlled chemical reaction, chemical vapor deposition (CVD), cross-linking, partial polymerization, ion exchange, ion stuffing, or directional solidification.

7. (canceled)

8. The method of claim 1, wherein placing the plurality of components on the optical circuit board includes:
placing a portion of the components on two opposite surfaces of the optical circuit board.

9. (canceled)

10. The method of claim 1, further comprising:
forming a layer of conductive traces over at least one surface of the non-linear GRIN optical backplane.

11. The method of claim 1, wherein placing the plurality of components on the optical circuit board includes:
attaching the plurality of components to the optical circuit board by one or more of gluing, soldering, and/or ultrasonic welding.

12. An apparatus, comprising:
a gradient index (GRIN) optical backplane of an optical circuit board;
a plurality of components placed on the GRIN optical backplane based on an approximate angle of incidence for one or more optical pathways through the GRIN optical backplane, and placed on the GRIN optical backplane to enable an optical communication signal projection from an optical interface coupled to an edge of the GRIN optical backplane to arrive at one or more of the placed plurality components, the one or more optical pathways located between a component and other components or the optical interface; and
the optical interface configured to receive a first optical communication signal and provide the first optical communication signal to at least one of the components through at least one of the optical pathways in the GRIN optical backplane.

13. The apparatus of claim 12, wherein the optical interface is further configured to receive a second optical communication signal from at least one of the components through an optical pathway in the GRIN optical backplane and to provide the second optical communication signal to an external destination.

14. The apparatus of claim 12, wherein the GRIN optical backplane is formed from a single GRIN material.

15. The apparatus of claim 14, wherein the GRIN material includes one of: poly(methyl methacrylate), perfluorinated polymers, cyclo-olefin polymers, polysulfones, sulfonated polystyrene, silica glass with gradient varying additions, or fluoride glass.

16. The apparatus of claim 12, wherein the GRIN optical backplane comprises a sheet that includes x, y, and z axes and includes at least one refractive index that non-linearly varies along at least one of the x, y, and z axes of the sheet.

17. The apparatus of claim 12, wherein the GRIN optical backplane comprises a sheet that includes x, y, and z axes and includes at least one refractive index that linearly varies along at least one of the x, y, and z axes of the sheet.

18. The apparatus of claim 12, further comprising a layer of conductive traces on at least a surface of the GRIN optical backplane.

19. The apparatus of claim 12, wherein the first optical communication signal is one or more of a laser beam, an infrared beam, or a visible light beam.

20. The apparatus of claim 12, wherein the GRIN optical backplane has non-linear refractive indices such that optical communication signals directed to different components cross each other without interference.

21. The apparatus of claim 12, wherein the GRIN optical backplane has non-linear refractive indices such that two or more optical communication signals are directed to different components from a single emanation point at the optical interface.

22. The apparatus of claim 21, wherein the GRIN optical backplane has non-linear refractive indices such that a multiplex of frequencies of the optical communication signals projects the optical communication signals to one or more components.

23. The apparatus of claim 12, wherein a portion of the plurality of components include at least one of an emitter and/or a detector configured to facilitate projection and/or reception of the optical communication signals.

24.-29. (canceled)

30. An optical backplane, comprising:
a gradient index (GRIN) material formed as at least one sheet, wherein the sheet includes x, y, and z axes, wherein the GRIN material has at least one refractive index that non-linearly varies along at least one of the x, y, and z axes of the sheet and the at least one refractive index is arranged in the GRIN material such that optical communication signals directed to different components, located on at least one surface of the GRIN material, cross each other without interference; and
at least one optical pathway in the GRIN material and configured with a direction based on the non-linear variation of the at least one refractive index.

31.-32. (canceled)

33. The optical backplane of claim 30, wherein the at least one sheet of the GRIN material is formed from two or more parallel layers of distinct refractive indices in a uniform progression.

34. The optical backplane of claim 33, wherein the two or more parallel layers are formed in one of a horizontal orientation or a diagonal orientation.

35. The optical backplane of claim 33, wherein the uniform progression of the refractive indices is from a relatively higher refractive index to a relatively lower refractive index, from a top surface of the GRIN material to a bottom surface of the GRIN material.

36. (canceled)

37. The optical backplane of claim 30, wherein the at least one refractive index that non-linearly varies is present along the z axis, and a substantially constant refractive index is present along the x and y axes.

38.-39. (canceled)

40. The optical backplane of claim 30, wherein the at least one refractive index that non-linearly varies is arranged in the GRIN material such that two or more optical communication signals are directed to different components, located on at least one surface of the GRIN material, from a single emanation point at an optical interface.

41. The optical backplane of claim 30, wherein the at least one refractive index that non-linearly varies is arranged in the GRIN material such that a multiplex of frequencies of optical communication signals projects the optical communication signals to one or more components located on a surface of the GRIN material.

42. A method to operate an optical backplane, the method comprising:
outputting an optical communication signal from a first component located on at least one surface of a gradient index (GRIN) material formed as at least one sheet, wherein the sheet includes x, y, and z axes, wherein the GRIN material has at least one refractive index that non-linearly varies along at least one of the x, y, and z axes of the sheet; and
projecting the optical communication signal from the first component to a second component, located on the at least one surface of the GRIN material, via at least one optical pathway in the GRIN material, wherein the optical communication signal travels in the optical pathway along a direction based on the non-linear variation of the at least one refractive index.

43.-44. (canceled)
